(19) United States
(12) Patent Application Publication
(10) Pub. No.: US 2006/0258381 A1
(43) Pub. Date: Nov. 16, 2006

(54) Method and apparatus for transmitting digital data

(75) Inventor: Pierre Dupuy, Paris (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/490,098

(22) Filed: Jul. 21, 2006

Related U.S. Application Data
(63) Continuation of application No. 09/715,171, filed on Nov. 20, 2000.

(30) Foreign Application Priority Data
Nov. 22, 1999 (FR) 99 14 634

(51) Int. Cl. H04Q 7/20

(52) U.S. Cl. 455/466

(57) ABSTRACT

To resolve a data rate problem that results from a channel having a standardized data rate that is limited and too low between two synchronized relays, provision is made for causing the channel to be asynchronous and for providing the receiving relay with a buffer memory, preferably of the first-in-first-out type. It is shown that under such circumstances for data rates higher than the data rates of the limited data rate channels, synchronization no longer gives rise to a systematic loss of time.

This is a continuation of application Ser. No. 09/715,171 filed Nov. 20, 2000. The entire disclosure of the prior application, application Ser. No. 09/715,171, is considered part of the disclosure of the accompanying divisional application and is hereby incorporated by reference.

The present invention relates to a transmission method and apparatus usable essentially for transmitting digital data, in particular data formatted in the General Packet Radio Service (GPRS) standard. In a preferred use, the invention is implemented in the context of transmitting data to a mobile telephone, e.g. to display on the screen of the mobile telephone the results of a visit to an Internet site. More generally, the invention is for adapting the GPRS protocol to equipment implemented for radio transmission of the type used in the Global System for Mobile Communications (GSM).

### BACKGROUND OF THE INVENTION

Implementing the GPRS protocol requires certain magnitudes, and in particular certain bit rates to be used that present practical difficulties when the data is to be carried over paths used in telephony. For example, in GSM mode, provision is made to distribute thirteen frames in 60 milliseconds (ms). This leads to each of the frames having a duration of 4.61538 ms. In GPRS mode, this base duration of 60 ms is designed to take three data messages, or three data blocks over a circuit. Each data message or block is distributed in compliance with GSM mode over four time windows each of 577 microseconds (pts) (assuming there are eight time windows per frame) In practice this leads to having a data rate of one data message per 20 ms duration. Consequently, provision is made for the operation of the various pieces of transmission equipment involved from 30 one end of the chain to the other to be synchronized on 20 ms (50 Hz).

To transmit data to a mobile telephone, the necessary fixed equipment comprises, in a base station (BS), equipment known as a base station controller (BSC). The BSC equipment controls a base transceiver station (BTS) constituting a radio interface between the BSC and a mobile telephone. A BSC controls one or more BTSs. It manages the radio resource: it allocates channels for calls and it takes decisions concerning base station transfer (handover). Allocating a channel comprises designating time windows in the frames and carrier frequencies or encoding laws for TDMA or CDMA type systems respectively (time division multiple access or code division multiple access respectively). In order to limit the cost of transceiver stations with fixed BTS equipment, the BTS equipment does no processing other than digital-to-analog conversion and modulation or amplification processing. In practice, links between BSCs and BTSs comprise channels rated at 16 kilobits per second (kbit/s), and actually implemented as 64 kbit/s channels each capable of carrying four paths. Other data rates could have been selected. Nevertheless, for mass production reasons, the equipment now in place and the equipment which is being installed nowadays, is made with that rate limit.

When transmitting data packets or messages in GPRS mode, several working rates have been envisaged. Thus, there are coding schemes of types CS1, CS2, CS3, and CS4 capable respectively of carrying payload data rates equal to 8800 bits/s, 12,800 bits/s, 15,200 bits/s, and 20,800 bits/s, respectively. In practice, the numbers of bits transmissible in a duration of 20 ms (corresponding to the GPRS repetition rate) are then respectively 176 bits, 256 bits, 310 bits, and 416 bits. When the data rate in a channel between the BSC and the BTS of a base station is restricted to 16 kbit/s, then the times required for transmitting these payload bits are respectively 12 ms, 17 ms, 21 ms, and 28 ms. In theory, these transmission times should be less than the values given above, but because of the need to encapsulate the payload bits that are transmitted over the channel at 16 kbit/s, the time required for sending both the data and the signaling leads to the overall times given above. These various coding schemes are organized so that within frames of 1500 bytes (i.e. 12 kilobits), the contribution given to redundancy becomes smaller and smaller on going from CS1 protocol to CS4 protocol.

In any event, it can clearly be seen that the time required for transmitting data corresponding to data messages of CS3 type lasts for 21 ms, i.e. longer than the time available at the GPRS repetition rate. As a result of this situation, sending a data block with CS3 type encoding will lead to transmission between the BSC and the BTS of a duration that is longer than the repetition period. Consequently, a following repetition period will need to be ignored in order to make it possible in a third period to consider transmitting a second CS3 type block. This leads to the paradox whereby although the theoretical CS3 bit rate of 15,200 bits/s is greater than the CS2 bit rate of 12,800 bits/s, the real rate actually achieved when using CS3 (with lower redundancy and thus greater fragility relative to the channel) actually takes place at a rate of about 7700 bits/s. This rate is less than the CS2 rate, and CS2 is, in addition, better protected.

### OBJECT AND SUMMARY OF THE INVENTION

The object of the invention is to ensure that with the less well protected CS3 type encoding, the actual rate is at least greater than that of the better protected CS2 type encoding. It is explained below that the usable data rate with the CS3 type encoding when using the invention is equal to twelve-thirteenths of the theoretical rate, i.e. 14.03 kbit/s. This leads to a loss of approximately 7.7% compared with the theoretical rate. Nevertheless, even with this reduction, the CS3 rate remains 9.6% higher than the CS2 rate. It is also shown that if the radio channel for transmission between the base station and the mobile telephone is not very good, CS3 can accommodate a bit error rate of up to 8% without its overall rate being excessively affected.

Although the invention is also applicable to CS4 type encoding, its usable rate drops from the theoretical rate of 20.8 kbit/s to 14.4 kbit/s. That is to say almost the same (only a little better) than that of the CS3 type encoding. Nevertheless, it will be observed that this disadvantage is of little importance since normal radio transmission conditions make this coding scheme impractical for most of the time. Since this scheme is not protected by sufficient redundancy, its error bit rate is very high. Under such circumstances, the usable bit rate drops very significantly.

The invention also seeks to remedy the above drawbacks in a manner that is particularly simple.

One of the solutions that could be used for remedying this problem would be either to increase the usable bit rate of the channels providing links between BSCs and BTSs, or else to place all of the circuits for adapting, decoding, and correcting the protocols of bits received and of bits to be transmitted in the BTSs. Nevertheless, such a solution would suffer from the drawback of requiring BTSs to be fitted with processing means, which would increase the cost thereof considerably whereas the resources already available in the BSCs are capable of performing the functions of adapting and converting protocol without special difficulty. Without going into details, protocol adaptation or conversion consists, essentially, in transforming a packet transmission code usable upstream from the BSC circuits in the GPRS standard into a mode suitable for transmission over the circuits that are usable downstream therefrom. By selecting the circuits connected to the subscriber to be reached, the BSC circuits implement a final stage in the circuit switching that is required for conveying the message.

Compared with the above expensive solutions, it would also be possible to provide for abandoning the repetition rate. However such a solution would not be compatible with the standards in force.

The invention thus provides transmission apparatus comprising a first relay receiving data messages formatted in a first protocol from a transmitter and converting the data received in this way into data formatted in a second protocol, a second relay connected to the first relay and receiving the data messages formatted in the second protocol and transmitting them in a synchronous mode to a receiver, and a limited data rate transmission channel interconnecting the two relays, wherein, since said data messages formatted in said second protocol can be of different lengths, said apparatus includes means for transmitting said data messages that can be of different lengths over said limited data rate transmission channel in an asynchronous mode.

The invention also provides a transmission method comprising the following steps:
receiving, in a first relay, messages formatted in a first protocol and coming from a transmitter;
converting the data received in this way into data formatted in a second protocol;
transmitting the data formatted in the second protocol to a second relay connected to the first relay by a limited data rate transmission channel; and
transmitting, in a synchronous mode, the data formatted in the second protocol from the second relay to a receiver;

wherein said data messages formatted in said second protocol can be of different lengths, said method including transmitting said data messages capable of having different lengths over said limited data rate transmission channel in an asynchronous mode.

### BRIEF DESCRIPTION OF THE DRAWINGS

The invention will be better understood on reading the following description and on examining the accompanying figures. The figures are given purely by way of indication and do not limit the invention in any way. The figures show:

FIG. 1: a block diagram of transmission apparatus of the invention;

FIG. 2: a timing chart showing various standardized transmission schemes in the GPRS protocol; and

FIG. 3: a timing chart showing how a channel is used between the two relays, in the prior art and in the invention.

### MORE DETAILED DESCRIPTION

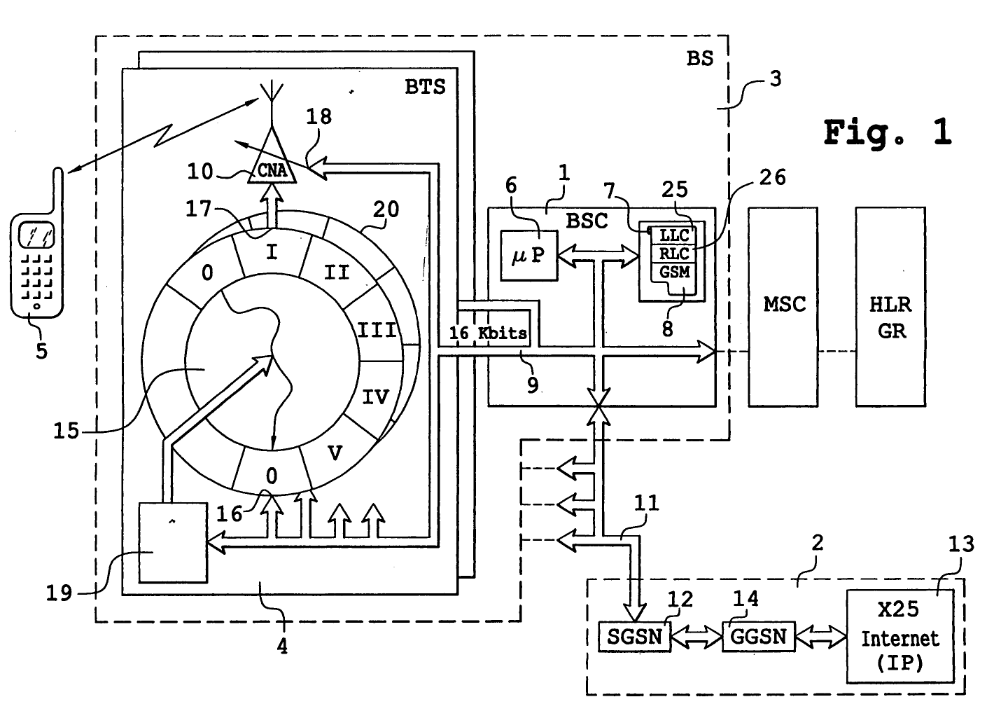

FIG. 1 shows transmission apparatus of the invention. This transmission apparatus comprises a first relay 1 receiving data messages from a transmitter 2 that are formatted in a first protocol. To clarify ideas, the relay 1 is a base station control circuit (BSC) of a base station (BS) 3. In practice, the same control circuit 1 can govern one or more second relays such as 4. In this case, the second relays 4 are merely the radio transceivers (BTS) constituting a radio interface between the first relay, the BSC circuits 1, and receivers such as mobile telephones 5. In the context of mobile telephony, or more generally in transmitting data to mobiles, the BSC 1 has means, in particular processor units 6 implementing programs 7, for managing data communication between the BTSs 4 and the mobiles 5. In the programs 7, this management is identified by a subprogram 8 referenced GSM in this case. In practice, a BTS 4 receives over a transmission channel 9 data which has already been formatted in a GSM protocol. In the BTS 4, complex processing is undertaken. In particular, the BTS is capable of implementing forward error correction (FEC) methods and error detection methods. These methods are used in particular to detect whether a received block is valid or not. The data is symbolized in this case as being transmitted to a digital-to-analog converter (DAC) 10 of the BTS 4. This digital-to-analog converter 10 is also capable of performing modulation and variable gain amplification of radio signals intended for the mobile 5. Preferably, in order to reduce cost, a BTS 4 contains only a radio transmitter portion (and a receiver portion) together with means for performing modulation and digital-to-analog conversion. These circuits are very simple. The channel 9 also suffers from the drawback of being rated for a limited data rate, in this case commonly to 16 kbit/s. This drawback is associated with an advantage: base station equipment can be standardized and of low cost.

The transmitter 2 in this case is a transmitter transmitting data signals formatted in the GPRS standard over a transmission channel 11. As explained in the book “Réseaux GSM-DCS” [GSM-DCS networks] by Xavier Lagrange et al., Editions Hermes, Paris 1997, at pages 326 et seq., the GPRS defines a packet switched network architecture with management of mobility and access by radio. A GPRS network can be connected to various fixed data networks relying on various protocols: Internet protocol (IP), and also X25, connection-oriented protocol, and connectionless network protocol (CLNP). In addition, a plurality of GPRS networks can be interconnected.

FIG. 1 shows that for this purpose the transmitter 2 has a serving GPRS support node (SGSN) 12 which is connected to one or more base stations such as 3. The node 12 is connected to a packet transmission network 13, an X25 network, or the Internet, for example, via a gateway GPRS support node (GGSN) 14. The gateway node 14 can be connected to one or more data networks such as the network 13. The node 14 is a router which enables packets coming from external data networks to be conveyed via the node 12 to the base station 3, in particular the control circuits 1 of said base station 3.

In the description above, the first relay 1 receives data in a GPRS protocol from the transmitter 2, and transmits it to the second relay 4 in a second protocol, in this case the GSM protocol. The second relay, the base station 4, transmits the data to the receiver 5. Naturally, the installation also operates in the opposite direction. Protocol conversion could also be different from the adaptation mentioned above, and could even be reduced to mere relaying.

In a characteristic of the invention, the second relay, in this case the BTS 4, includes a buffer memory 15 which is preferably of the first-in-first-out (FIFO) type. It is not necessarily of this type if transmission to the mobile takes place in packet mode (assuming each packet has an order number). To simplify the diagram, a memory 15 is shown in the form of a rotating memory having a write input 16 for the memory 15, and a read output 17 from the memory 15. Naturally, the memory does not revolve mechanically, but write address pointers and read address pointers merely allow new data to be written in new cells of the memory 15 and allow data that has been previously been written to the cells to be taken therefrom. The bus 9 is thus connected firstly to the input 16 and secondly to a control input 18 for controlling the circuits 10 that perform digital-to-analog conversion, modulation, amplification, and radio transmission. The input 18 which receives the signaling that accompanies the packets to be transmitted enables the circuits 10 to be adjusted. Shown in this way, the memory 15 is preferably of the FIFO type, with messages I to V being stored therein in that order prior to being extracted therefrom in the same order. On the received side, the same type of connection is implemented.

In an improvement of the invention, the memory 15 is associated with a decoder 19 that is also connected to the bus 9 and that is capable of receiving an instruction to retransmit a message that has previously been stored and that has already been transmitted. For example, the memory 15 has messages of ranks 0, I, II, III, IV, V etc. in its various cells. The message I is being transmitted by the circuits 10. After the message I has been transmitted, the message II is to be transmitted. Then the message III and the message IV, and so on. Under normal circumstances, the read pointer 17 for the memory 15 addresses its various cells so as to extract the messages I, II, III, IV, V, etc. therefrom. However it can happen that the message of rank 0 is not properly received by the mobile 5.

In an improvement, the decoder 19, on decoding an instruction, can then either change the read pointer 17 temporarily so that it rereads at some given instant the message of rank 0, thereby retransmitting it, or else can rewrite the message of rank 0 behind the message of rank V in the memory 15 so that this memory will be retransmitted subsequently. The purpose of the instruction executed in this way is to avoid having to retransmit the content of the message 0 over the limited data rate channel 9 when the control circuit 1 becomes aware that it has not been properly received by the receiver 5, and providing knowledge of such poor reception is obtained while the message 0 is still stored in the memory 15. By acting in this way, there is no need to retransmit the poorly received message of rank 0 twice over the bus 9.

Just as it is possible for a control circuit 1 to govern a plurality of BTSs such as 4, so it is possible for a control circuit 1 to govern for a single BTS 4 a plurality of channels such as 9 feeding a plurality of buffer memories such as 15, e.g. a memory 20. Under such circumstances, the effectiveness of the improvement provided by the invention can be further increased. In an improved mode, provision is made to achieve data rates of 60 kbit/s per time window using new modulation. Under such circumstances, the radio modulation provided by the circuit 10 is modified. Under these conditions, it is possible to envisage moving on to the CS4 scheme. In which case, the various channels such as 9 can be used to feed the various memories 15 or 20 or more generally a common memory of larger size. If a message such as the message 0 needs to be repeated, then there will be no need for the message to be repeated in the same time window.

Although the description above is made on the basis of implicit addressing between a 16 kbit/s channel 9 and a radio time window for GSM transmission, in the future explicit addressing will exist. This explicit addressing will either be conveyed by a signaling channel between the control circuit 1 and the BTS 4, or else the explicit addressing will be transmitted in packet mode in the messages such as I to V that the BTS 4 will then be capable of interpreting. Under such conditions, a time window can be designated at the last moment, thus making the buffer memory that much more advantageous.

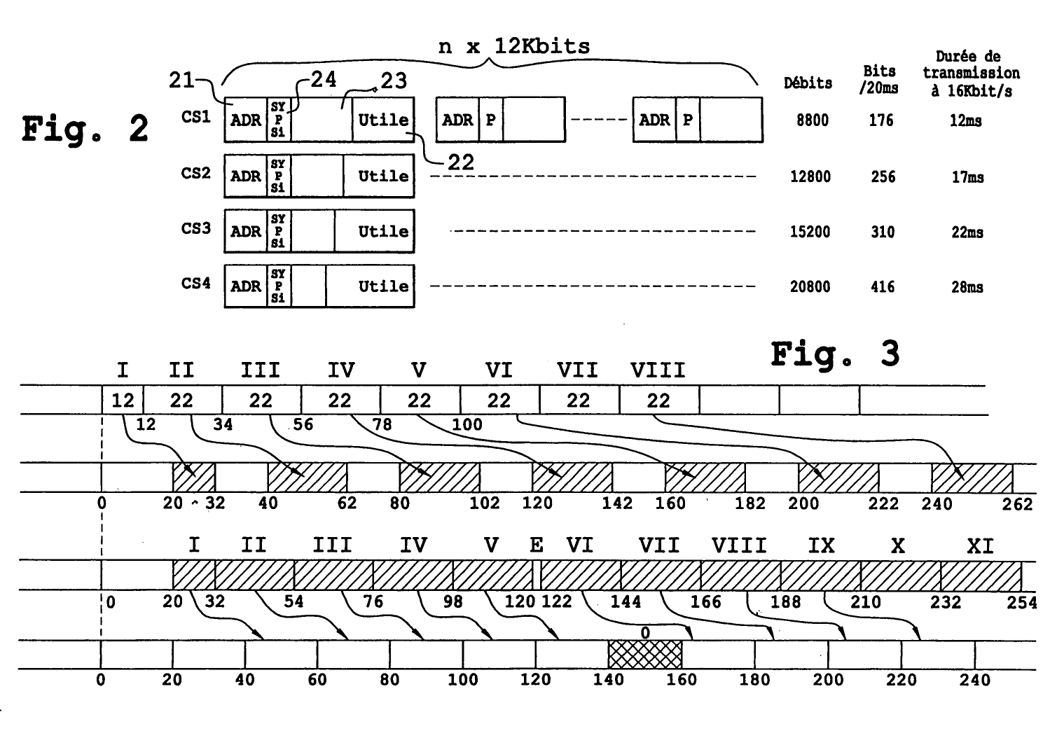

FIG. 2 summarizes the various coding schemes CS1 to CS4 that can be used for transmitting data in the GPRS protocol. In this protocol, 1500-byte frames, i.e. 12 kbit/s, are conveyed in packets. Each packet has an address portion 21, a payload data portion 22, and a payload data redundancy portion 23. In addition, each packet includes synchronization information SY, transmitter power information P, and signaling SI. The synchronization signals enable the operation of the BTS 4 to be timed. In this case they are used at least for timing the read pointer 17. The power signals P are used in conventional manner for controlling the power operation of the transmitter circuits 10 via the input 18. The signaling signals can be signals of various types, and in particular, in the context of the invention, can include instructions suitable for being decoded by the decoder 19. From the scheme CS1 to the scheme CS4, the payload data portion becomes larger while the redundancy portion becomes smaller. This leads to payload data rates lying in the range 8800 bits/s to 20,800 bits/s. The payload bits transmissible per 20 ms period thus go from 176 to 416 as mentioned above. For each message designated in this way, the time required for transmission over a 16 kbit/s transmission channel leads to durations running from 12 ms to 28 ms. The processing circuits 6 and 7 perform conventional type processing 25 (LLC) and 26 (RLC). They are capable of extracting from the packets received over the bus 11 the payload bits to be transmitted over the bus 9. They transmit them in a GSM format together with signaling signals.

FIG. 3 shows transmission mode in the state of the art and in the invention respectively. A first line at the top of FIG. 3 shows sequentially in time: messages to be transmitted numbered I to VIII and having transmission durations that depend on the coding scheme used and that are marked. These durations are 12 ms or 22 ms in this example. The second line from the top of the figure shows the effects of the timing imposed by implementing the GPRS standard directly without desynchronization and without waiting time. In effect, the second line shows how the channel 9 is occupied when it is run in application of the GPRS standard. In this case, 20 ms time windows are provided. To enable a data message, e.g. message I, to be transmitted in a time window, it is necessary for the message firstly to have been received in full in the circuits 1 before the beginning of the time window that is to be used for transmitting it. This applies, for example, after 20 ms for message I, so the message I can be transmitted for a duration of 12 ms during a second window. Between the times extending from 32 ms, the end of transmission of message I, and 40 ms, the beginning of the third window, the channel 9 is unoccupied. At 40 ms, message II which was received between times 12 ms and 34 ms can be transmitted during the third time window beginning at time 40 ms. However, the message II occupies 22 ms for transmission, i.e. it occupies part of the fourth time window extending from 60 ms to 80 ms. Consequently, this fourth window leaves the channel 9 empty of any transmission during the remaining 18 ms. And so on, such that with the CS3 scheme, the channel 9 is occupied for about half of its theoretical maximum. This leads to the paradox mentioned above whereby the data rate using coding scheme CS3 which ought to give a higher data rate is on the contrary slower than using the lower data rate coding scheme CS2.

In the invention, 20 ms timing is abandoned for the channel 9. Consequently, in this channel 9, transmission takes place in asynchronous mode. As a result, as can be seen in the third line of FIG. 3, messages I to XI are transmitted while making maximum use of the data rate available in channel 9. The third line shows both how channel 9 is occupied and how the input of the memory 15 is occupied. In the same manner as for the second line in FIG. 3, in the third line, the buffer memory 15 is loaded with the message I over a duration lying between times 20 ms and 32 ms. Consequently, during the time window from 20 ms to 40 ms no message can be transmitted by the BTS 4 to the receiver 5. The 12 ms message I is transmitted during the time window extending from 40 ms to 60 ms.

By fitting the BTS relay of the base station with equipment that is very simple: a buffer memory, preferably of the FIFO type, operation takes place as follows: the blocks to be transmitted are stored in advance in asynchronous mode in the BTS relay. Thereafter, they are taken from the buffer memory at a rate corresponding to GSM transmission. With GSM transmission, a theoretical maximum rate of 250 kbit/s between a BTS relay and a mobile telephone can be envisaged (assuming that all time windows in the frames are allocated to the same mobile telephone). There is no risk of the memory saturating. Under such conditions, the transmission link between the BSC circuits and the BTS relay is at its maximum capacity: 16 kbit/s.

As mentioned above, GSM transmission mode possesses a data rate in excess of 16 kbit/s. At such a higher data rate, during the fourth period 60 ms to 80 ms, the message II available in the memory 15 can be sent by the base station towards the mobile 5. It can easily be shown that message V, which begins to be transmitted at 120 ms, could have been sent to the memory 15 in the period situated between 98 ms and 120 ms. However, message VI, for which reception by the memory 15 terminates at time 144 ms, is unavailable for transmission during the following window 140 ms to 160 ms. This window is thus ignored. It will be observed that instructions for ignoring and controlling the memory 15 can be sent as signaling data in the messages transmitted and decoded by the decoder 19. As a result, message VI is transmitted by the base station 4 only during times 160 ms and 180 ms. Thus, it can be seen that at time 260 ms, using the invention, message X can have been sent whereas using the state of the art solution only messages I to VII can have been sent. This shows clearly the increase in data rate provided by the invention. It is observed that this data rate increase is achieved in spite of the poor data rate on the channel 9, and also while complying with GPRS mode timing.

In the state of the art as in the invention it is possible that the coding scheme CS3 which is less robust against radio transmission channel noise will cause certain messages, e.g. the message 0 as mentioned above, to be transited without success. In the state of the art, it is necessary to consider the message 0 as being another message to be sent and consequently retransmission of that message would further reduce the efficiency of transmission since the message would need

1. A method for performing a conversion between transmission on a radio interface where messages of variable size are sent or received at fixed and regular time intervals and with a variable rate, and transmission on terrestrial interfaces using fixed rate channels, the method comprising transmitting said messages of variable size to be sent or received at fixed and regular time intervals following each other without any time interval between each other, instead of at fixed and regular time intervals, so as to optimize use of available bandwidth on said channels.

2. A device for performing a conversion between transmission on a radio interface where messages of variable size are sent or received at fixed and regular time intervals and with a variable rate, and transmission on terrestrial interfaces using fixed rate channels, said device comprising means for transmitting said messages of variable size to be sent or received following each other without any time interval between each other, instead of at fixed and regular time intervals, so as to optimize use of available bandwidth on said channels.
